(19) United States
(12) Patent Application Publication
(10) Pub. No.: US 2026/0035838 A1
(43) Pub. Date: Feb. 5, 2026

(54) THERMOPLASTIC POLYESTER ELASTOMER YARN AND METHOD FOR MANUFACTURING THE SAME

(71) Applicant: NAN YA PLASTICS CORPORATION, TAIPEI (TW)

(72) Inventors: CHIH-WEN CHEN, New Taipei City (TW); CHENGN-SHUI HUANG, New Taipei City (TW); HUI-SHIH LIN, Taoyuan City (TW); SHU-YUN CHANG, Yilan City (TW)

(21) Appl. No.: 18/908,750

(22) Filed: Oct. 7, 2024

(30) Foreign Application Priority Data
Aug. 2, 2024 (TW) 113128870

(51) Int. Cl. D01F 6/62; C08L 67/02; D01D 5/08

(52) U.S. Cl. CPC D01F 6/62; C08L 67/025; D01D 5/08; C08L 2207/04; C08L 2207/20; D10B 2331/04

(57) ABSTRACT

A thermoplastic polyester elastomer yarn and a method for manufacturing the same are provided. The method for manufacturing the thermoplastic polyester elastomer yarn includes: providing a thermoplastic polyester elastomer; and performing a melt spinning process by using the thermoplastic polyester elastomer to produce the thermoplastic polyester elastomer yarn. The thermoplastic polyester elastomer includes s 50% to 70% by weight of a soft segment and 30% to 50% by weight of a hard segment, and the intrinsic viscosity of the thermoplastic polyester elastomer is between 1.1 dL/g and 1.6 dL/g. The spinneret used in the melt spinning process is formed with patterned spinneret holes, which include a merging-yarn area and a plurality of pseudo-yarn areas. The pseudo-yarn areas are symmetrically distributed around the merging-yarn area, and each pseudo-yarn area is in communication with the merging-yarn area. The number of pseudo-yarn areas is three or more.

### CROSS-REFERENCE TO RELATED PATENT APPLICATION

This application claims the benefit of priority to Taiwan Patent Application No. 113128870, filed on Aug. 2, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a thermoplastic polyester elastomer yarn and a method for manufacturing the same, and more particularly to a high-denier thermoplastic polyester elastomer yarn and a method for manufacturing the same.

### BACKGROUND OF THE DISCLOSURE

Currently, most fibers are manufactured using dry spinning. In the dry spinning process, a polymer is dissolved in a solvent to form a spinning solution. After the spinning solution is extruded through a spinneret and formed, it enters a heated gas, where the solvent in the spinning solution evaporates due to the high temperature, so as to form fine polymer filaments. However, traditional dry spinning requires a large amount of solvent during the process, thus raising many environmental concerns.

To ensure complete evaporation of the solvent, the thickness of a single yarn strand cannot be too high, typically ranging from 10 denier to 20 denier (den). To obtain higher denier yarn, a plurality of yarn strands need to be combined through methods such as friction bonding or air pressure to form plied yarn. However, due to the impact of the bonding method, there is significant variation in the appearance of each plied yarn, leading to issues of uneven quality.

When yarn is manufactured using melt spinning, although higher denier yarn can be manufactured, the yarn tends to slip off the yarn cake and break during the weaving process due to insufficient contact area and friction.

Therefore, improving the manufacturing method to enhance the quality of high-denier yarn and improve subsequent processing conditions has become one of the key challenges in this field.

### SUMMARY OF THE DISCLOSURE

The technical problem to be solved by the present disclosure is to address the deficiencies of the prior art by providing a thermoplastic polyester elastomer yarn and a method for manufacturing the same.

To solve the aforementioned technical problem, one of the technical solutions adopted by the present disclosure is to provide a method for manufacturing a thermoplastic polyester elastomer yarn. The method for manufacturing the thermoplastic polyester elastomer yarn includes: providing a thermoplastic polyester elastomer comprising 50% to 70% by weight of a soft segment and 30% to 50% by weight of a hard segment, in which an intrinsic viscosity of the thermoplastic polyester elastomer ranges from 1.1 dL/g to 1.6 dL/g; and conducting a melt spinning process by using the thermoplastic polyester elastomer to produce the thermoplastic polyester elastomer yarn, in which a spinneret used in the melt spinning process is formed with patterned spinneret holes; in which the patterned spinneret holes comprise a merging-yarn area and a plurality of pseudo-yarn areas, the plurality of pseudo-yarn areas are symmetrically distributed around the merging-yarn area, each of the plurality of pseudo-yarn areas is in communication with the merging-yarn area, and a number of the plurality of pseudo-yarn areas is three or more.

In certain embodiments, the hard segment of the thermoplastic polyester elastomer comprises polyethylene terephthalate, polybutylene terephthalate, or a combination thereof.

In certain embodiments, the hard segment of the thermoplastic polyester elastomer is derived from recycled waste materials.

In certain embodiments, the soft segment of the thermoplastic polyester elastomer comprises polyethylene glycol, polyether polyol, polytetramethylene ether glycol, or a combination thereof.

In certain embodiments, a diameter of each of the plurality of pseudo-yarn areas ranges from 0.4 mm to 3.0 mm.

In certain embodiments, a spacing between two adjacent pseudo-yarn areas ranges from 0.05 mm to 3.0 mm.

In certain embodiments, a ratio of a diameter of each of the plurality of pseudo-yarn areas to the spacing between two adjacent pseudo-yarn areas ranges from 0.133 to 60.

In certain embodiments, the merging-yarn area has a plurality of connecting sections that are in communication with each other, a number of the plurality of connecting sections is the same as a number of the plurality of pseudo-yarn areas, and each of the plurality of connecting sections is in communication with one of the plurality of pseudo-yarn areas.

In certain embodiments, a length of each of the plurality of connecting sections ranges from 0.1 mm to 0.3 mm.

In certain embodiments, a width of each of the plurality of connecting sections ranges from 0.01 mm to 0.5 mm.

In certain embodiments, a ratio of a diameter of each of the plurality of pseudo-yarn areas to a length of each of the plurality of connecting sections ranges from 1.33 to 30.

In certain embodiments, a ratio of a diameter of each of the plurality of pseudo-yarn areas to a width of each of the plurality of connecting sections ranges from 0.8 to 300.

In certain embodiments, a curvature radius of each of the plurality of pseudo-yarn areas ranges from 10 micrometers to 45 micrometers.

To solve the aforementioned technical problem, another technical solution adopted by the present disclosure is to provide a thermoplastic polyester elastomer yarn manufactured by the method as mentioned above, in which a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

In certain embodiments, a denier of the thermoplastic polyester elastomer yarn ranges from 15 to 100.

In certain embodiments, the outer radius ranges from 40 micrometers to 170 micrometers.

In certain embodiments, the inner radius ranges from 25 micrometers to 115 micrometers.

One of the advantageous effects of the present disclosure is that the thermoplastic polyester elastomer yarn and the method for manufacturing the same provided by the present disclosure can produce high surface area and high denier thermoplastic polyester elastomer yarn by employing the technical solutions of “the intrinsic viscosity of the thermoplastic polyester elastomer being between 1.1 dL/g and 1.6 dL/g,” “the patterned spinneret holes including a merging-yarn area and a plurality of pseudo-yarn areas,” and “the plurality of pseudo-yarn areas being symmetrically distributed around the merging-yarn area, with each pseudo-yarn area being in communication with the merging-yarn area.”

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective schematic diagram of the spinneret of the present disclosure.

FIG. 2 is a schematic diagram of the patterned spinneret holes in the first embodiment of the method for manufacturing thermoplastic polyester elastomer yarn according to the present disclosure.

FIG. 3 is a schematic diagram of the thermoplastic polyester elastomer yarn according to the present disclosure.

FIG. 4 is a schematic diagram of the patterned spinneret holes in the second embodiment of the method for manufacturing thermoplastic polyester elastomer yarn according to the present disclosure.

FIG. 5 is a schematic diagram of the patterned spinneret holes in the third embodiment of the method for manufacturing thermoplastic polyester elastomer yarn according to the present disclosure.

FIG. 6 is a schematic diagram of the patterned spinneret holes in the third embodiment of the present disclosure.

FIG. 7 is a schematic diagram of the patterned spinneret holes in Comparative Example 1 of the present disclosure.

FIG. 8 is a schematic diagram of the patterned spinneret holes in Comparative Example 2 of the present disclosure.

FIG. 9 is a schematic diagram of the patterned spinneret holes in Comparative Example 3 of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The following describes the embodiments of the present disclosure related to “a thermoplastic polyester elastomer yarn and a method for manufacturing the same” through specific examples. Those skilled in the art can understand the advantages and effects of the present disclosure based on the content disclosed in this specification. The present disclosure can be implemented or applied in other different specific embodiments, and the details in this specification can be variously modified and changed without departing from the spirit of the present disclosure, depending on different perspectives and applications. Additionally, the figures of the present disclosure are merely simplified schematic illustrations and are not drawn to actual scale, as previously stated. The following embodiments will further detail the relevant technical content of the present disclosure, but the disclosed content is not intended to limit the scope of protection of the present disclosure. Furthermore, the term “or” as used herein should be interpreted to possibly include any one or more of the listed items.

To address the aforementioned issues, the present disclosure provides a thermoplastic polyester elastomer yarn and a method for manufacturing the same. By selecting materials and designing patterned spinneret holes, high-denier yarn with uniform quality can be manufactured.

The present disclosure produces yarn by using the melt spinning method, and the manufactured thermoplastic polyester elastomer yarn is integrally formed without the need for additional steps such as friction bonding or air pressurization to combine a plurality of yarn strands into plied yarn. Therefore, the method for manufacturing thermoplastic polyester elastomer yarn according to the present disclosure has the advantage of being relatively simple. Additionally, the thermoplastic polyester elastomer yarn manufactured by the present disclosure has an appropriate surface area, providing sufficient friction during the weaving process, making it less likely to slip off the yarn cake and break.

The method for manufacturing thermoplastic polyester elastomer yarn according to the present disclosure includes the following steps: providing a thermoplastic polyester elastomer (S1); and performing a melt spinning process by using the thermoplastic polyester elastomer to produce a thermoplastic polyester elastomer yarn (S2).

In S1, the selected thermoplastic polyester elastomer comprises 50% to 70% by weight of a soft segment and 30% to 50% by weight of a hard segment. In a preferred embodiment, the content of the soft segment in the thermoplastic polyester elastomer is higher than the content of the hard segment.

That is to say, the content of the soft segment in the thermoplastic polyester elastomer is greater than 50% by weight and up to 70% by weight, for example, an integer between 50% by weight and 70% by weight. The content of the hard segment in the thermoplastic polyester elastomer is between 30% by weight and less than 50% by weight, for example, an integer between 30% by weight and less than 50% by weight.

In an exemplary embodiment, the soft segment in the thermoplastic polyester elastomer may be formed from polyethylene glycol (PEG), polyether polyol (PPG), polytetramethylene ether glycol (PTMEG), or a combination thereof. The weight-average molecular weight of the monomers constituting the soft segment may be between 500 g/mol and 4000 g/mol, for example, an integer between 500 g/mol and 4000 g/mol.

In an exemplary embodiment, the hard segment in the thermoplastic polyester elastomer may be formed from polyethylene terephthalate, polybutylene terephthalate, or a combination thereof, but the present disclosure is not limited thereto. In another exemplary embodiment, the hard segment in the thermoplastic polyester elastomer may be derived from recycled waste. Specifically, the hard segment in the thermoplastic polyester elastomer may be formed from recycled thermoplastic polyester elastomer (rTPEE) obtained by depolymerizing PET waste such as plastic bottles.

The intrinsic viscosity of the thermoplastic polyester elastomer may be between 1.1 dL/g and 1.6 dL/g. For example, the intrinsic viscosity may be 1.15 dL/g, 1.20 dL/g, 1.25 dL/g, 1.30 dL/g, 1.35 dL/g, 1.40 dL/g, 1.45 dL/g, 1.50 dL/g, or 1.55 dL/g. Within the aforementioned range of intrinsic viscosity, the thermoplastic polyester elastomer is particularly suitable for manufacturing the high-denier thermoplastic polyester elastomer yarn of the present disclosure.

In S2, the melt spinning process involves feeding the thermoplastic polyester elastomer pellets into the feed hopper of a melt spinning machine. The thermoplastic polyester elastomer pellets are conveyed by a screw to a heating zone, where they are heated at a temperature ranging from 190° C. to 270° C. to form molten thermoplastic polyester elastomer. The molten thermoplastic polyester elastomer is then passed through a filtration device and conveyed through a feed pipe to the spinning box. At a spinning temperature of 200° C. to 270° C., the molten thermoplastic polyester elastomer is quantitatively extruded through the spinneret, then cooled by air and oiled before being wound at a winding speed of 500 meters per minute to 2000 meters per minute to obtain the thermoplastic polyester elastomer yarn.

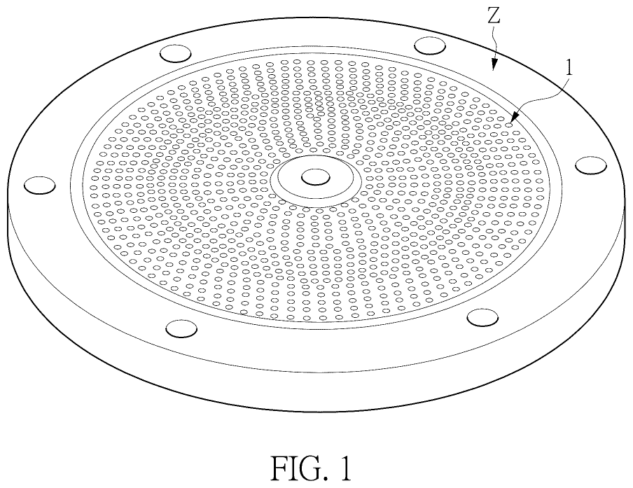

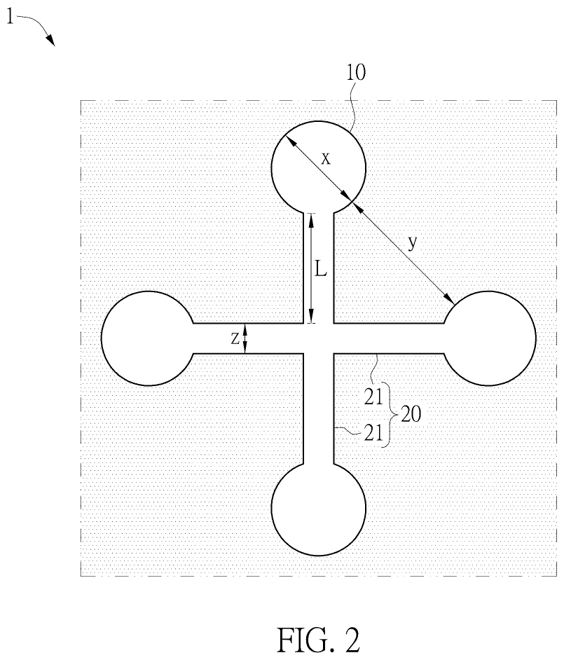

Reference is made to FIG. 1 and FIG. 2. In the spinning box, the pressurized molten thermoplastic polyester elastomer is extruded through the patterned spinneret holes 1 on the spinneret Z, and the thermoplastic polyester elastomer yarn is obtained after cooling.

In the present disclosure, the patterned spinneret holes 1 on the spinneret Z are designed with a plurality of pseudo-yarn areas 10 and a merging-yarn area 20. The plurality of pseudo-yarn areas 10 are symmetrically distributed around the merging-yarn area 20, and each of the plurality of pseudo-yarn areas 10 is in communication with the merging-yarn area 20.

In the first embodiment (the structure shown in FIG. 2), the patterned spinneret hole 1 has four pseudo-yarn areas 10, symmetrically distributed around the merging-yarn area 20. The merging-yarn area 20 includes a plurality of connecting sections 21 that are in communication with each other and are symmetrically distributed in a radial pattern. Specifically, the number of connecting sections 21 is the same as the number of pseudo-yarn areas 10, that is, the merging-yarn area 20 has four connecting sections 21. Each of the plurality of connecting sections 21 is in communication with one of the plurality of pseudo-yarn areas 10.

It should be particularly noted that when the pressurized molten thermoplastic polyester elastomer first passes through the patterned spinneret hole 1, it retains a shape corresponding to the patterned spinneret hole 1. After exiting the patterned spinneret hole 1, due to the drop in external pressure, the thermoplastic polyester elastomer expands until the internal and external pressures of the material reach equilibrium. As a result, the shape of the thermoplastic polyester elastomer yarn is not exactly the same as the shape of the patterned spinneret hole, but some parts still correspond.

It is further explained that regarding the original shape of the patterned spinneret hole, the thermoplastic polyester elastomer yarn would theoretically have an arc surface (the pseudo-yarn area 10) with an angle greater than 270 degrees, but due to expansion, the actual thermoplastic polyester elastomer yarn may retain an arc surface with an angle of less than 200 degrees. The arcuate portions on the thermoplastic polyester elastomer yarn can increase the surface area of the yarn, thereby enhancing the frictional force between the yarns during subsequent processing.

According to the aforementioned design, after passing through the plurality of pseudo-yarn areas 10, the thermoplastic polyester elastomer expands to form structures resembling individual yarn strands (the pseudo-yarn section). After passing through the merging-yarn area 20, the thermoplastic polyester elastomer expands to connect the plurality of pseudo-yarn sections, making the interior of the thermoplastic polyester elastomer yarn solid. Therefore, the thermoplastic polyester elastomer yarn of the present disclosure is integrally formed and has a solid structure.

In the first embodiment, the patterned spinneret hole has four pseudo-yarn areas 10; thus, after S1 and S2, a structure similar to plied yarn formed from four yarn strands can be obtained.

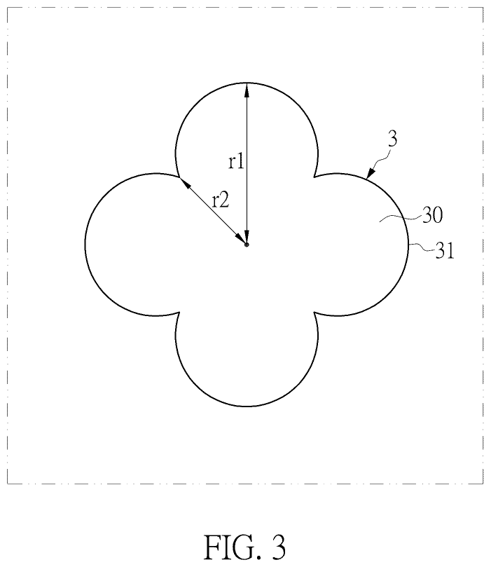

Reference is made to FIG. 3. In the cross-section of the thermoplastic polyester elastomer yarn 3, the thermoplastic polyester elastomer yarn 3 has four pseudo-yarn sections 30 that are outwardly protruding, and each pseudo-yarn section 30 has an arcuate surface 31. The outwardly protruding arcuate surface 31 increases the surface area of the thermoplastic polyester elastomer yarn 3. As previously mentioned, the pseudo-yarn sections 30 are mainly formed from the thermoplastic polyester elastomer passing through the pseudo-yarn areas 10.

Based on the arcuate surface 31 of the thermoplastic polyester elastomer yarn 3, the curvature radius of the pseudo-yarn sections 30 can be measured. In one exemplary embodiment, the curvature radius of the pseudo-yarn sections 30 is between 10 micrometers and 45 micrometers, for example, an integer between 10 micrometers and 45 micrometers.

Please refer again to FIG. 2. In the size design of the patterned spinneret hole 1, the pseudo-yarn area 10 can be circular or other geometric shapes. When the pseudo-yarn area 10 is circular, the diameter x of the pseudo-yarn area 10 can be between 0.4 mm and 3.0 mm. For example, the diameter x of the pseudo-yarn area 10 can be 0.6 mm, 0.8 mm, 1.0 mm, 1.2 mm, 1.4 mm, 1.6 mm, 1.8 mm, 2.0 mm, 2.2 mm, 2.4 mm, 2.6 mm, or 2.8 mm. When the pseudo-yarn area 10 is another geometric shape, the major diameter of the geometric shape is between 0.4 mm and 3.0 mm.

The spacing y between two adjacent pseudo-yarn areas 10 can be between 0.05 mm and 3.0 mm. For example, the spacing y between two adjacent pseudo-yarn areas 10 can be 0.1 mm, 0.2 mm, 0.4 mm, 0.6 mm, 0.8 mm, 1.0 mm, 1.2 mm, 1.4 mm, 1.6 mm, 1.8 mm, 2.0 mm, 2.2 mm, 2.4 mm, 2.6 mm, or 2.8 mm.

The length L of the connecting section 21 can be between 0.1 mm and 0.3 mm. For example, the length L of the connecting section 21 can be 0.15 mm, 0.2 mm, or 0.25 mm. The width z of the connecting section 21 can be between 0.01 mm and 0.5 mm. For example, the width z of the connecting section 21 can be 0.05 mm, 0.1 mm, 0.15 mm, 0.2 mm, 0.25 mm, 0.3 mm, 0.35 mm, 0.4 mm, or 0.45 mm.

In one exemplary embodiment, to increase the surface area of the thermoplastic polyester elastomer yarn, the ratio of the diameter x of the pseudo-yarn area 10 to the length L of the connecting section 21 can be between 1.33 and 30. For example, the ratio of the diameter x of the pseudo-yarn area 10 to the length L of the connecting section 21 can be an integer between 1.33 and 30.

In other embodiments, the ratio of the diameter x of the pseudo-yarn area 10 to the width z of the connecting section 21 can be between 0.8 and 300. For example, the ratio of the diameter x of the pseudo-yarn area 10 to the width z of the connecting section 21 can be an integer between 0.8 and 300.

In yet other embodiments, the ratio of the diameter x of the pseudo-yarn area 10 to the spacing y between two adjacent pseudo-yarn areas 10 can be between 0.133 and 60. For example, the ratio of the diameter x of the pseudo-yarn area 10 to the spacing y between two adjacent pseudo-yarn areas 10 can be an integer between 0.133 and 60.

Please refer again to FIG. 3. In the structure of the thermoplastic polyester elastomer yarn, the cross-section of the thermoplastic polyester elastomer yarn has an outer radius r1 and an inner radius r2. The outer radius r1 refers to the maximum distance from the center of the thermoplastic polyester elastomer yarn to its outer edge, and the inner radius r2 refers to the minimum distance from the center of the thermoplastic polyester elastomer yarn to its outer edge. Therefore, the outer radius r1 is greater than the inner radius r2.

In one exemplary embodiment, the outer radius r1 is between 40 micrometers and 170 micrometers, and the inner radius r2 is between 25 micrometers and 115 micrometers. For example, the outer radius r1 can be an integer between 40 micrometers and 170 micrometers, and the inner radius r2 can be an integer between 25 micrometers and 115 micrometers.

Since the outer radius r1 is greater than the inner radius r2, the ratio of the outer radius r1 to the inner radius r2 is between 1.2 and 5. For example, the ratio of the outer radius r1 to the inner radius r2 can be 1.5, 2.0, 2.5, 3.0, 3.5, 4.0, or 4.5.

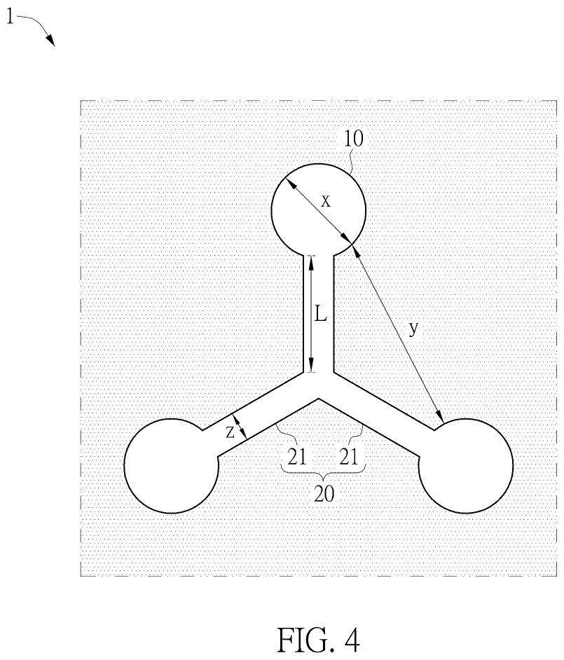

Reference is made to FIG. 4. The patterned spinneret hole 1 in the second embodiment of the present disclosure has three pseudo-yarn areas 10, symmetrically distributed around the merging-yarn area 20. The merging-yarn area 20 includes three connecting sections 21 that are symmetrically distributed in a radial pattern and in communication with each other, and each connecting section 21 is in communication with one of the plurality of pseudo-yarn areas 10. In this way, the structure formed by the patterned spinneret hole 1 in the second embodiment is similar to plied yarn formed from three yarn strands.

In the second embodiment, the diameter x of the pseudo-yarn area 10, the length L of the connecting section 21, and the width z of the connecting section 21 are similar to those in the first embodiment and are therefore not repeated here. It should be specifically noted that the spacing y between two adjacent pseudo-yarn areas 10 can be between 0.5 mm and 3.0 mm. For example, the spacing y between two adjacent pseudo-yarn areas 10 can be 1.2 mm, 1.4 mm, 1.6 mm, 1.8 mm, 2.0 mm, 2.2 mm, 2.4 mm, 2.6 mm, or 2.8 mm.

In one exemplary embodiment, to increase the surface area of the thermoplastic polyester elastomer yarn, the ratio of the diameter x of the pseudo-yarn area 10 to the spacing y between two adjacent pseudo-yarn areas 10 can be controlled to be between 0.133 and 6. For example, the ratio of the diameter x of the pseudo-yarn area 10 to the spacing y between two adjacent pseudo-yarn areas 10 can be an integer between 0.133 and 6.

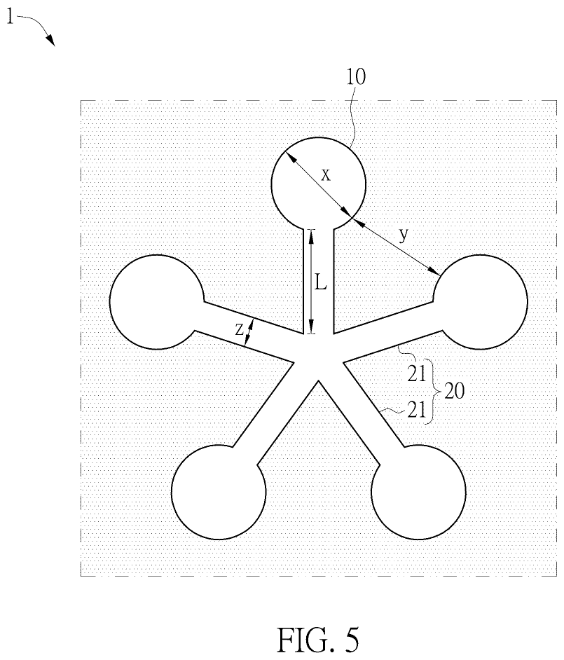

Reference is made to FIG. 5. The patterned spinneret hole 1 in the third embodiment of the present disclosure has five pseudo-yarn areas 10, symmetrically distributed around the merging-yarn area 20. The merging-yarn area 20 includes five connecting sections 21 that are symmetrically distributed in a radial pattern and in communication with each other, with each connecting section 21 in communication with one of the pseudo-yarn areas 10. In this way, the structure formed by the patterned spinneret hole 1 in the third embodiment is similar to plied yarn formed from five yarn strands.

In the third embodiment, the diameter x of the pseudo-yarn area 10, the length L of the connecting section 21, and the width z of the connecting section 21 are similar to those in the first embodiment and are therefore not repeated here. It should be specifically noted that the spacing y between two adjacent pseudo-yarn areas 10 can be between 0.05 mm and 2.0 mm. For example, the spacing y between two adjacent pseudo-yarn areas 10 can be 0.1 mm, 0.2 mm, 0.4 mm, 0.6 mm, 0.8 mm, 1.0 mm, 1.2 mm, 1.4 mm, 1.6 mm, or 1.8 mm.

In one exemplary embodiment, to increase the surface area of the thermoplastic polyester elastomer yarn, the ratio of the diameter x of the pseudo-yarn area 10 to the spacing y between two adjacent pseudo-yarn areas 10 can be further controlled to be between 0.2 and 60. For example, the ratio of the diameter x of the pseudo-yarn area 10 to the spacing y between two adjacent pseudo-yarn areas 10 can be an integer between 0.2 and 60.

### Experimental Data

To verify that the manufacturing method of the present disclosure can produce high-denier thermoplastic polyester elastomer yarn that is not prone to slippage in subsequent processing, commercially available thermoplastic polyester elastomer (model Hytrel® 4056) is used as the raw material. After heating and melting, it is quantitatively extruded through a spinneret at a spinning temperature of 190° C. to 260° C. to produce the thermoplastic polyester elastomer yarn for Examples 1 to 3 and Comparative Examples 1 to 3.

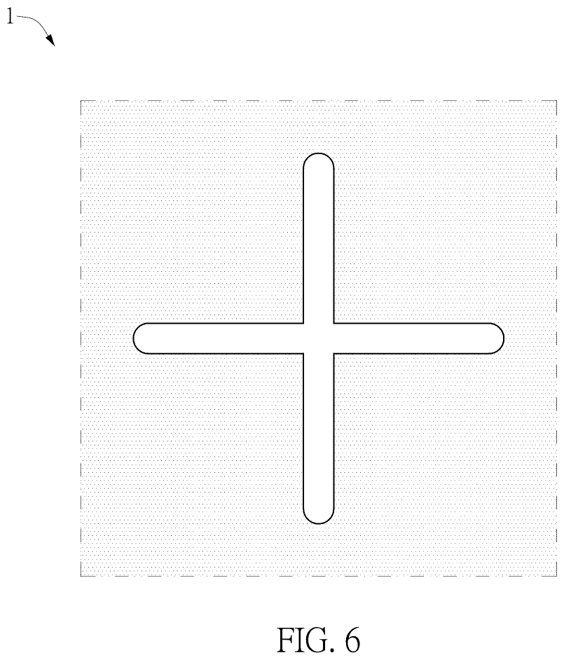

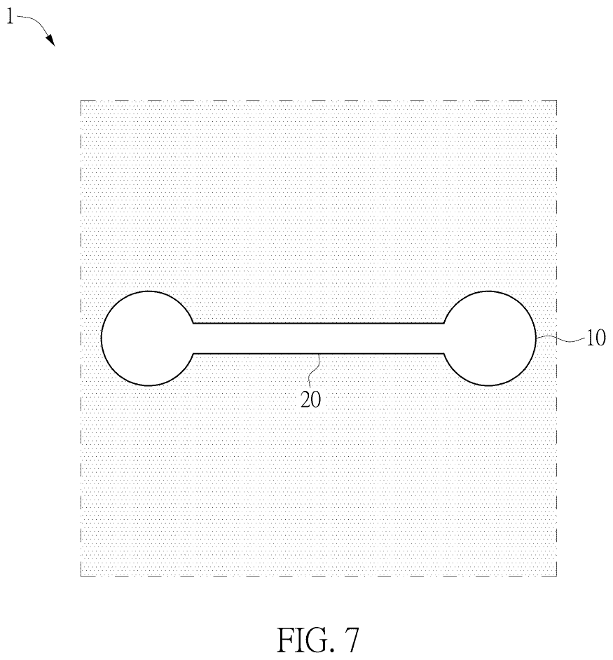

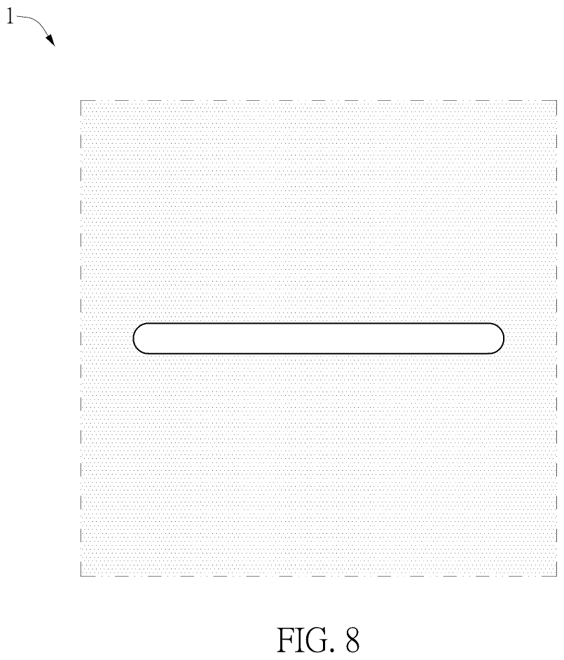

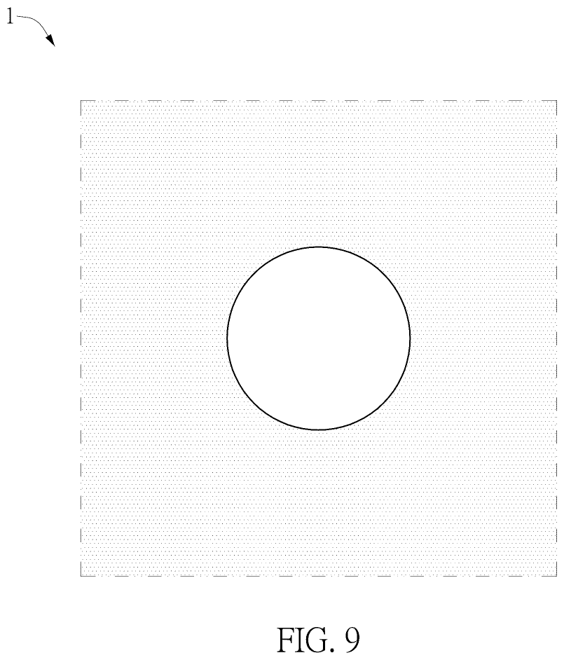

The differences between Examples 1 to 3 and Comparative Examples 1 to 3 lie in the patterned spinneret holes on the spinneret. The patterned spinneret hole in Example 1 is as shown in FIG. 2 (First Embodiment), with four pseudo-yarn areas. The patterned spinneret hole in Example 2 is as shown in FIG. 4 (Second Embodiment), with three pseudo-yarn areas. The patterned spinneret hole in Example 3 is as shown in FIG. 6, with four pseudo-yarn areas, and the diameter of the pseudo-yarn area is the same as the width of the connecting section. The patterned spinneret hole in Comparative Example 1 is as shown in FIG. 7, with two pseudo-yarn areas. The patterned spinneret hole in Comparative Example 2 is as shown in FIG. 8, with two pseudo-yarn areas, and the diameter of the pseudo-yarn area is the same as the width of the connecting section. The patterned spinneret hole in Comparative Example 3 is as shown in FIG. 9, which is circular, meaning that there is no distinction between pseudo-yarn areas and merging-yarn areas in Comparative Example 3.

The thermoplastic polyester elastomer yarn in Examples 1 to 3 and Comparative Examples 1 to 3 have similar yarn strengths. The yarn strength of the thermoplastic polyester elastomer yarn is measured by using a STATIMAT 4 automatic tensile tester manufactured by Textechno, according to ASTM D 885 standard test methods, and the specific yarn strength is listed in Table 1. The elongation of the thermoplastic polyester elastomer yarn is also measured using the automatic tensile tester according to ASTM D 885 standard test methods, and the results are listed in Table 1.

To test whether the thermoplastic polyester elastomer yarn is prone to slippage during subsequent processing, 128 spools of thermoplastic polyester elastomer yarn, each weighing 500 grams, are knitted using a circular knitting machine. The number of slips of the thermoplastic polyester elastomer yarn during a single knitting process is counted, and the average slip count is recorded. The average slip count is listed in Table 1.

TABLE 1

| | Example | | | Comparative Example | | |
|---|---|---|---|---|---|---|
| | 1 | 2 | 3 | 1 | 2 | 3 |
| Structure of | Four pseudo-yarn | Three pseudo-yarn | Four pseudo-yarn | Two pseudo-yarn | Two pseudo-yarn | No distinction |
| patterned nozzles | areas, with the | areas, with the | areas, with the | areas, with the | areas, with the | between pseudo- |
| Spinneret Hole | diameter of the | diameter of the | diameter of the | diameter of the | diameter of the | yarn area and |
| | pseudo-yarn area | pseudo-yarn area | pseudo-yarn area | pseudo-yarn area | pseudo-yarn area | merging-yarn |
| | greater than the | greater than the | equal to the | greater than the | equal to the | area |
| | width of the | width of the | width of the | width of the | width of the | |
| | connecting section | connecting section | connecting section | connecting section | connecting section | |
| Yarn Strength | 1.2 | 1.2 | 1.3 | 1.2 | 1.3 | 1.3 |
| (g/denier) | | | | | | |
| Elongation (%) | 417 | 435 | 411 | 408 | 413 | 442 |
| Slip Count (times) | ≤1 | ≤1 | ≤1 | 2-3 | 4-8 | >8 |

From the results in Table 1, it can be seen that when the patterned spinneret hole is designed with three or more pseudo-yarn areas, the thermoplastic polyester elastomer yarn can achieve a larger surface area, which prevents it rom easily slipping due to insufficient friction during subsequent processing, thereby avoiding production interruptions.

### Beneficial Effects of the Embodiments

One of the advantages of the present disclosure is that the thermoplastic polyester elastomer yarn and the method for manufacturing the same provided by the present disclosure can achieve a high surface area and high denier thermoplastic polyester elastomer yarn through the technical solutions of “the intrinsic viscosity of the thermoplastic polyester elastomer being 1.1 dL/g to 1.6 dL/g,” “the patterned spinneret hole comprising a merging-yarn area and a plurality of pseudo-yarn areas,” and “the plurality of pseudo-yarn areas being symmetrically distributed around the merging-yarn area, with each pseudo-yarn area in communication with the merging-yarn area.”

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a thermoplastic polyester elastomer yarn, comprising:
providing a thermoplastic polyester elastomer comprising 50% to 70% by weight of a soft segment and 30% to 50% by weight of a hard segment, wherein an intrinsic viscosity of the thermoplastic polyester elastomer ranges from 1.1 dL/g to 1.6 dL/g; and
conducting a melt spinning process by using the thermoplastic polyester elastomer to produce the thermoplastic polyester elastomer yarn, wherein a spinneret used in the melt spinning process is formed with patterned spinneret holes; wherein the patterned spinneret holes comprise a merging-yarn area and a plurality of pseudo-yarn areas, the plurality of pseudo-yarn areas are symmetrically distributed around the merging-yarn area, each of the plurality of pseudo-yarn areas is in communication with the merging-yarn area, and a number of the plurality of pseudo-yarn areas is three or more.

2. The method for manufacturing according to claim 1, wherein the hard segment of the thermoplastic polyester elastomer comprises polyethylene terephthalate, polybutylene terephthalate, or a combination thereof.

3. The method for manufacturing according to claim 1, wherein the hard segment of the thermoplastic polyester elastomer is derived from recycled waste materials.

4. The method for manufacturing according to claim 1, wherein the soft segment of the thermoplastic polyester elastomer comprises polyethylene glycol, polyether polyol, polytetramethylene ether glycol, or a combination thereof.

5. The method for manufacturing according to claim 1, wherein a diameter of each of the plurality of pseudo-yarn areas ranges from 0.4 mm to 3.0 mm.

6. The method for manufacturing according to claim 1, wherein a spacing between two adjacent pseudo-yarn areas ranges from 0.05 mm to 3.0 mm.

7. The method for manufacturing according to claim 1, wherein a ratio of a diameter of each of the plurality of pseudo-yarn areas to the spacing between two adjacent pseudo-yarn areas ranges from 0.133 to 60.

8. The method for manufacturing according to claim 1, wherein the merging-yarn area has a plurality of connecting sections that are in communication with each other, a number of the plurality of connecting sections is the same as a number of the plurality of pseudo-yarn areas, and each of the plurality of connecting sections is in communication with one of the plurality of pseudo-yarn areas.

9. The method for manufacturing according to claim 8, wherein a length of each of the plurality of connecting sections ranges from 0.1 mm to 0.3 mm.

10. The method for manufacturing according to claim 8, wherein a width of each of the plurality of connecting sections ranges from 0.01 mm to 0.5 mm.

11. The method for manufacturing according to claim 8, wherein a ratio of a diameter of each of the plurality of pseudo-yarn areas to a length of each of the plurality of connecting sections ranges from 1.33 to 30.

12. The method for manufacturing according to claim 8, wherein a ratio of a diameter of each of the plurality of pseudo-yarn areas to a width of each of the plurality of connecting sections ranges from 0.8 to 300.

13. A thermoplastic polyester elastomer yarn manufactured by the method according to claim 1, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

14. The thermoplastic polyester elastomer yarn according to claim 13, wherein a denier of the thermoplastic polyester elastomer yarn ranges from 15 to 100.

15. The thermoplastic polyester elastomer yarn according to claim 13, wherein the outer radius ranges from 40 micrometers to 170 micrometers.

16. The thermoplastic polyester elastomer yarn according to claim 13, wherein the inner radius ranges from 25 micrometers to 115 micrometers.

17. The thermoplastic polyester elastomer yarn according to claim 13, wherein a curvature radius of each of the plurality of pseudo-yarn areas ranges from 10 micrometers to 45 micrometers.

18. A thermoplastic polyester elastomer yarn manufactured by the method according to claim 2, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

19. A thermoplastic polyester elastomer yarn manufactured by the method according to claim 3, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

20. A thermoplastic polyester elastomer yarn manufactured by the method according to claim 4, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

21. A thermoplastic polyester elastomer yarn manufactured by the method according to claim 5, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

22. A thermoplastic polyester elastomer yarn manufactured by the method according to claim 6, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

23. A thermoplastic polyester elastomer yarn manufactured by the method according to claim 7, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

24. A thermoplastic polyester elastomer yarn manufactured by the method according to claim 8, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

25. A thermoplastic polyester elastomer yarn manufactured by the method according to claim 9, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

26. A thermoplastic polyester elastomer yarn manufactured by the method according to claim 10, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

27. A thermoplastic polyester elastomer yarn manufactured by the method according to claim 11, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.

28. A thermoplastic polyester elastomer yarn manufactured by the method according to claim 12, wherein a thermoplastic polyester elastomer yarn is integrally formed, the thermoplastic polyester elastomer yarn has a plurality of pseudo-yarn areas that are protruding outward, the thermoplastic polyester elastomer yarn has an outer radius and an inner radius, the outer radius is greater than the inner radius, and a ratio of the outer radius to the inner radius ranges from 1.2 to 5.
